(19) United States
(12) Patent Application Publication
(10) Pub. No.: US 2007/0121256 A1
(43) Pub. Date: May 31, 2007

(54) Portable electronic device carrying apparatus and method of use thereof

(76) Inventors: Monika R. Wolf, Parkland, FL (US); Matthew J. Johnson, Plantation, FL (US); David H. Karl, Fort Lauderdale, FL (US); James L. Tracy, Coral Springs, FL (US); Michael J. Page, Fort Lauderdale, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/286,474

(22) Filed: Nov. 26, 2005

(51) Int. Cl. H02H 7/00

(52) U.S. Cl. 361/1

(57) ABSTRACT

The invention concerns a portable carrying apparatus (100) and a method (800) of the operation thereof. In one arrangement, the portable carrying apparatus can include a holding device (104) and a clip (106). The holding device can be made of a material that is capable of transmitting light. A light source (302) can be activated by an activation device (410) to illuminate the holding device in the occurrence of an event. The method can also include configuring the duration as well as a sequence of illumination of the light source, depending on the event that takes place.

### BACKGROUND OF THE INVENTION

1. Field of the Invention

This invention relates in general to portable electronic devices and more particularly, to accessories for portable electronic devices.

2. Description of the Related Art

In today's marketplace, consumers have numerous portable electronic devices to choose from. Examples of these portable electronic devices include cellular telephones, MP3 players, and personal radios. Carrying these portable electronic devices may be a problem for a user, since they are easily misplaced.

In the case of a portable electronic device such as a mobile phone, the user can locate it by calling and hearing its ring tone. However, in a noisy or cluttered environment, it may be difficult to hear the ring tone and locate the mobile phone. Moreover, manufacturers of such devices and their related accessories are constantly searching for ways to distinguish their products from those sold by competitors.

### SUMMARY OF THE INVENTION

The present invention concerns an apparatus that is suitable for carrying a portable electronic device. The apparatus can include a holding device that can carry the portable electronic device and one or more light sources to illuminate the apparatus. The one or more light sources can be attached to the holding device, and can be activated, based on a predefined event. This event can be a timer alert in the portable electronic device, an incoming communication signal on it, the movement of the holding device or a signal from a sensor on it. The holding device can be made of a transparent or translucent material. The apparatus can also include an activation device that can receive signals from the portable electronic device. The activation device can activate the light source on receiving a signal from the portable electronic device.

The apparatus can also include one or more contacts that couple the activation device to the portable electronic device when the holding device is carrying the portable electronic device. Also, when the holding device is carrying the portable electronic device, the portable electronic device can control the operation of the activation device. In one arrangement, the contacts may intermittently lose touch with the portable electronic device when the holding device is moved such that the light source may intermittently activate when the holding device is moved. The apparatus may receive its power from a power supply of the portable electronic device or it may include its own power supply.

The present invention also concerns a portable carrying apparatus, which can include a portable electronic device, a holding device, an activation device, and one or more light sources. The holding device can hold the portable electronic device, while the activation device can receive signals from the portable electronic device. The one or more light sources may be coupled to the activation device and may also be attached to the holding device. The light source can selectively illuminate the portable carrying apparatus, based on the occurrence of a predefined event. Examples of the predefined event include, but are not limited to, a timer alert in the portable electronic device, an incoming communication signal on it, the movement of the holding device, or a signal from a sensor on the portable electronic device.

The present invention also concerns a method for notifying a user about an event. The method can be applied to a holding device that can carry a portable electronic device. The method can include the steps of the holding device receiving a signal from the portable electronic device when the holding device carries the portable electronic device and activating one or more light sources based on the signal received by the holding device. In one arrangement, the illumination of the light sources can be predefined.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an example of a holding device that is supporting or carrying a portable electronic device, in accordance with an embodiment of the inventive arrangements;

FIG. 2 illustrates a perspective view of a holding device suitable for carrying the portable electronic device of FIG. 1, in accordance with an embodiment of the inventive arrangements;

FIG. 3 illustrates a second perspective view of the holding device suitable for carrying the portable electronic device of FIG. 1, in accordance with an embodiment of the inventive arrangements;

FIG. 4 illustrates an example of a block diagram of the holding device and portable electronic device of FIG. 1, in accordance with an embodiment of the inventive arrangements; and

FIG. 5 illustrates an example of a method for notifying a user about an event, in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality” as used herein, is defined as two or more than two. The term “another” as used herein, is defined as at least a second or more. The terms “including” and/or “having” as used herein, are defined as comprising (i.e., open language). The term “coupled” as used herein, is defined as connected, although not necessarily directly, and not necessarily mechanically.

The invention concerns a portable carrying apparatus and a method of use thereof. In one arrangement, the apparatus can include a holding device that can carry a portable electronic device and at least one light source that can illuminate the apparatus on the occurrence of a predefined event. The light source can be attached to the holding device.

In one particular embodiment, the apparatus can also include an activation device. The activation device can receive signals from the portable electronic device and activate the light source in the holding device, in response to signals received. The apparatus can also include a power source that can supply electrical power to the light source. In view of this arrangement, the holding device can be illuminated based on certain processes occurring within the electronic device, such as the electronic device receiving a call. Also, the holding device may be illuminated based on its movement. Through such illumination, a user can be directed to his or her portable electronic device where the user may otherwise have overlooked the device. This feature can help manufacturers distinguish their products from others in the marketplace.

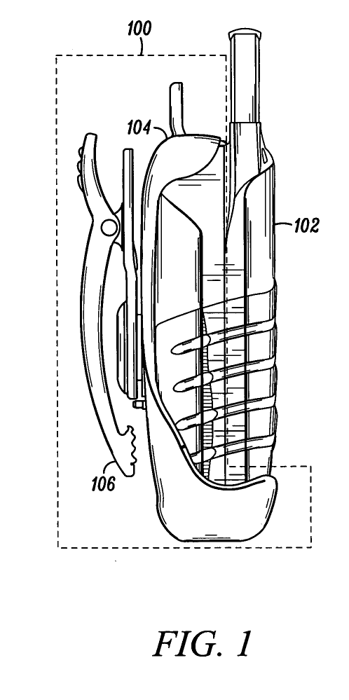

Referring to FIG. 1, an example of an apparatus 100 that is suitable for carrying a portable electronic device 102 is shown. In one embodiment, the apparatus 100 can include a holding device 104 and a clip 106. The holding device 104 can be made of a transparent or translucent material, so that the holding device 104 is capable of transmitting light. As is known in the art, the holding device 104 can detachably hold the portable electronic device 102. This enables the portable electronic device 102 to be removed from the holding device 104 when required. The clip 106 can enable a user to attach the apparatus 100 to an article of clothing or any other object, such as a dashboard of a vehicle. The clip 106 can enable the user to fasten the apparatus 100, in a removable manner, to an article that is present in the surroundings.

The holding device 104 can carry the portable electronic device 102, as shown in FIG. 1. The user can detach the portable electronic device 102 from the holding device 104, if required, for example, when the user receives a call or a message alert. The holding device 104 may be designed so that the user can easily detach the portable electronic device 102 from it, but the detachment should not occur without manual assistance. This may prevent inadvertent detachment and ensures the safety of the portable electronic device 102. In one arrangement, the portable electronic device 102 may be a mobile communications unit that is capable of receiving wireless communications signals, although the invention is not so limited.

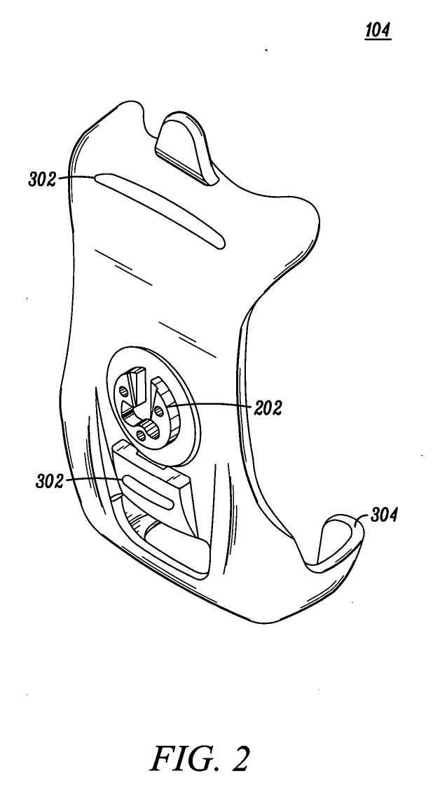

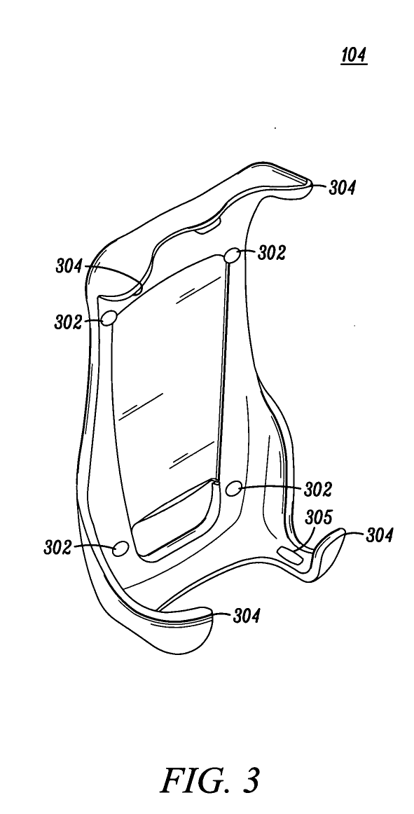

Referring to FIGS. 2 and 3, perspective views of the holding device 104 suitable for carrying the portable electronic device 102 of FIG. 1 are shown. In one embodiment, the holding device 104 can include a coupler 202 that can couple the holding device 104 with the clip 106 (see FIG. 1). The holding device 104 can also include at least one light source 302, which selectively illuminates the holding device 104, based on a predefined event. The holding device 104 can include more than one light source 302, in accordance with various embodiments of the invention. Examples of the light source 302 include, but are not limited to, a light emitting diode (LED), an incandescent bulb or an electro-fluorescent light source. The light source 302 can be positioned at any suitable location of the holding device 104 and may be attached to the holding device 104 in any suitable fashion. As such, the term “light source being attached to the holding device” can include the light source at lest being partially positioned on the outside of or at least partially embedded within the holding device 104.

The holding device 104 can be designed with protrusions 304, which can hold the portable electronic device 102. The holding device 104 can be formed to suit the shape of various portable electronic devices. The holding device 104 can have a different design for another portable electronic device with different external dimensions.

In one arrangement and referring to FIG. 3, the protrusions 304 may include one or more contacts 305. These contacts 305 can be used to electrically couple components of the holding device 104 to components of the portable electronic device 102 of FIG. 1. Examples of such components will be presented below. Although not shown here, the portable electronic device 102 can include one or more corresponding contacts. When the device 102 is placed in the holding device 104, the contacts 305 of the holding device 104 can be positioned against the contacts of the device 102. In addition, while shown as being positioned on the protrusions 304, it is important to note that the contacts 305 can be located at any other suitable location on the holding device 104.

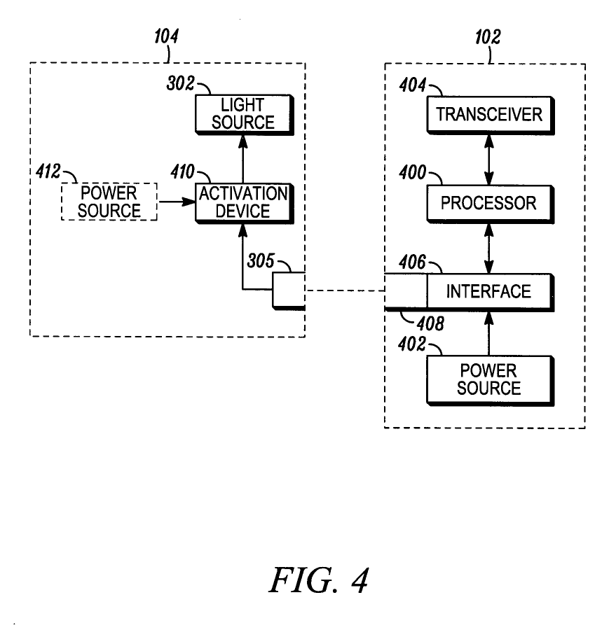

Referring to FIG. 4, a block diagram of some of the components of the portable electronic device 102 and the holding device 104 are shown. In one arrangement, the portable device 102 can include a controller or processor 400, a power source 402, a transceiver 404 and an interface 406 that can have one or more contacts 408. The holding device 104 may include one or more of the light sources 302, an activation device 410 and optionally, a power source 412.

The processor 400 can be coupled to and control the operation of the transceiver 404 and the interface 406. As is known in the art, the transceiver 404 can transmit and receive wireless signals. The interface 406 can be coupled to the power source 402 and can facilitate or control the flow of current from the power source 402 to the holding device 104 as well as control signals from the processor 400 or some other suitable component to the holding device 104. As an example, the power source 402 can be a rechargeable battery.

As noted earlier, the light source 302 can illuminate the holding device 104. Also, the activation device 410 can activate the light source 302. In particular, the activation device 410 can receive signals from the portable electronic device 102 and can activate the light source 302 in response to the signals. Examples of events that can trigger the activation source 410 to activate the light source 302 will be presented below. The activation device 410 can also be coupled to the contacts 305. If the holding device 104 includes the power source 412, the activation device 410 can control the flow of current from the power source 412 to the light source 302. As an example, the power source 412 can be a rechargeable battery. The activation device 410 can also control the flow of current from the power source 402 of the device 102. In one arrangement, the activation device 410 can include a timer, which can restrict the illumination of the light source 302 to a predetermined and possibly programmable amount of time.

In view of the arrangement described above, when the holding device 104 is supporting or carrying the portable electronic device 102, the contacts 408 of the device 102 can be coupled to the contacts 305 of the device 104. This coupling can allow power and control signals to pass from the portable device 102 to the holding device 104. Of course, those of skill in the art will appreciate that the portable device 102 and the holding device 104 can include suitable structure to enable signals to be passed between them without a direct physical connection. For example, the portable device 102 and the holding device 104 may be capacitively, inductively or magnetically coupled to one another.

As an example of the operation of the holding device 104, the portable electronic device 102 may be placed in the holding device 104. The contacts 305 of the holding device 104 and the contacts 408 of the device 102 can then engage one another. As a result, power from the power source 402 can be fed to the light source 302 through the contacts 305, 408 and the activation device 410, which can enable the light source 302 to illuminate. Alternatively, the interface 406 can detect the engagement of the contacts 305, 408 through any suitable means and can generate an interrupt to the processor 400. The processor 400, assuming that the charge on the power source 402 is acceptable, can signal the interface 406 to permit current to flow from the power source 402 to the holding device 104.

In yet another alternative, the processor 400 can pass control signals to the activation device 410 in response to the device 102 being positioned in the holding device 104. In response, the activation device 410 can allow current from the power source 402 or the power source 412 to pass to the light source 302.

There are several other ways to trigger the illumination of the light source 302 other than merely placing the portable device 102 in the holding device 104. For example, the activation device 410 can receive activation signals on the occurrence of one of the following events: a timer alert in the portable electronic device 102, an incoming communication signal on the portable electronic device 102, the movement of the holding device 104, a signal from a sensor on the portable electronic device 102, and the like.

Specifically, the portable electronic device 102 may include a calendar or some other application that keeps track of appointments or other scheduled events. When one of these events is about to occur, the processor 400 can signal the activation device 410, and one of the power sources 402, 412 can illuminate the light source 302. Alternatively, the portable device 102 can receive an incoming call, which can include any suitable type of incoming communication signal, and the processor 400 can signal the activation device 410 to correspondingly allow the light source 302 to be illuminated. In either example, the user can be alerted of important events or calls that may otherwise be overlooked.

It must be noted that the light source 302 can be illuminated in accordance with any predefined pattern. For example, the activation device 410 can cause the light source 302 to turn on and off based on a predetermined sequence. As an example, this sequence can be selected from a menu in the portable electronic device 102 or a user can generate his or her own sequence. In either embodiment, the processor 400 can signal the activation device 410 accordingly. Of course, the control of the light source 302 can be performed by the interface 406, based on instructions from the processor 400. As a result, the activation device 410 may not be a necessary part of the holding device 104.

As another example, the contacts 305 of the holding device 104 can be constructed to allow for temporary disengagement from the contacts 408 when the holding device 104 is moved. That is, the contacts 305 can be designed to intermittently lose touch with the contacts 408 of the device 102 when the holding device 104 is moved. For example, the contacts 305 can include a spring mechanism (not shown) that can permit them to intermittently contact the contacts 408. As such, the flow of current from the power source 402 can be intermittently interrupted, which can cause the light source 302 to correspondingly intermittently illuminate.

Of course, there are other ways to accomplish this function. In particular, the holding device 104 or the portable device 102 may be equipped with a motion detection mechanism (not shown), such as an accelerometer, and other suitable circuitry. When the motion detection mechanism detects movement of the holding device 104 (or the portable device 102), the processor 400 or some other suitable component can signal the activation device 410 to intermittently illuminate the light source 302. This can be useful for causing the holding device 104 to display an attractive sequence of lights when moved, for example, while a user is jogging or dancing.

An activation signal may also come from a sensor on the portable electronic device 102 or on the holding device 104. For example, the portable device 102 or the holding device 104 may include a temperature sensor or a light sensor. If either of these sensors detect a reading above or below a predetermined threshold or range, the activation device 410 can be signaled to selectively illuminate the light source 302 in response.

It must be noted that the invention is not limited to any of the examples above, as those of skill in the art will appreciate that there are many different ways to activate the light source 302 and many different events that can trigger the activation. In fact, there may be devices other than the portable electronic device 102 that may activate the light source 302 of the holding device 104, such as a key fob.

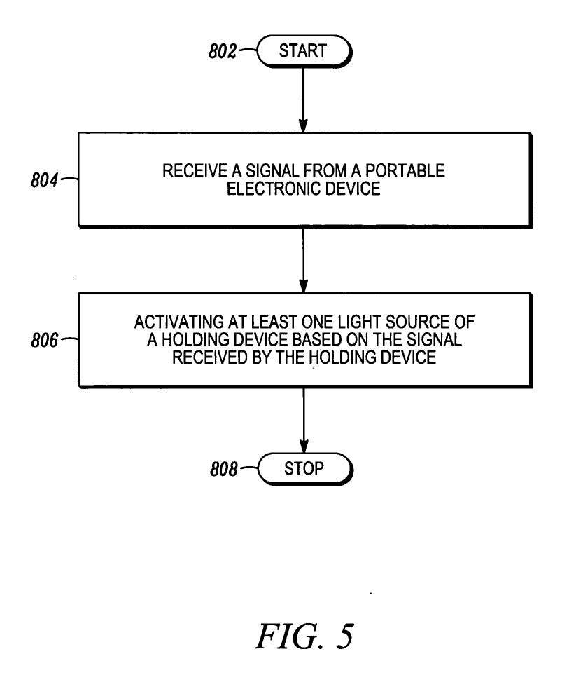

Referring to FIG. 5, an example of a method for notifying the user about an event is shown. To describe the method 800, reference is made to FIGS. 1-4, although it is understood that the method 800 can be implemented in any other suitable device or system. Moreover, the invention is not limited to the order in which the steps are listed in the method 800. Further, the method 800 can contain more or fewer steps than shown in FIG. 5. Several suitable examples of the method 800 are presented below.

In one arrangement, the method 800 can include one or more method steps for notifying the user about an event. At step 802, the method 800 can begin. At step 804, the holding device 104 can receive a signal while it carries the portable electronic device 102. The signal can be received by the holding device 104 by using an embodiment of the activation device 410, as described above. At step 806, the light source 302 of the holding device 104 can be activated, based on the signal received by the holding device 104. The method 800 can end at step 808.

In one arrangement, the apparatus 100 can have any or all of the embodiments described above. A combination of the embodiments can be used to activate the light source 302 in an aesthetically pleasing manner. An event such as an incoming call or a dispatch alert can trigger any of the activation device 410. The light source 302 can also be illuminated in a predefined manner, which can have some defaults settings and can also be user-configurable.

The user can, for example, configure the duration of the illumination or the sequence of the illumination of the light source 302. The user can associate a particular duration and sequence of illumination with an event, as described above. The event described above as being a timer alert in the portable electronic device 102, an incoming communication signal on the portable electronic device 102, a movement of the holding device, or a signal from a sensor on the portable electronic device 102 is merely an exemplary list. The duration and sequence of an illumination can be associated with each event and can be configured by the user. An event can include an occurrence that requires the attention of the user to be drawn to the portable electronic device 102, which has traditionally been accomplished by using methods such as a sound alert or a vibratory alert. The user can also locate a misplaced portable electronic device 102 using light illumination as a means for notifying the user of the location of the portable electronic device 102, as described above.

Where applicable, the present invention can be realized in hardware, software or a combination of hardware and software. Any kind of computer system or other apparatus adapted for carrying out the methods described herein are suitable. A typical combination of hardware and software can be a mobile communication device with a computer program that, when being loaded and executed, can control the mobile communication device such that it carries out the methods described herein.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. An apparatus suitable for carrying a portable electronic device, the apparatus comprising:
a holding device capable of carrying the portable electronic device; and
at least one light source for illuminating the apparatus, the light source being attached to the holding device, wherein the light source is activated based on a predefined event.

2. The apparatus according to claim 1, wherein the holding device is made of a translucent material.

3. The apparatus according to claim 1, further comprising an activation device that receives signals from the portable electronic device, wherein the activation device at least activates the light source in response to the receipt of signals from the portable electronic device.

4. The apparatus according to claim 3, further comprising one or more contacts that couple the activation device to the portable electronic device when the holding device is carrying the portable electronic device.

5. The apparatus according to claim 4, wherein when the holding device is carrying the portable electronic device, the portable electronic device controls the operation of the activation device.

6. The apparatus according to claim 4, wherein the contacts intermittently lose touch with the portable electronic device when the holding device is moved such that the light source is intermittently activated when the holding device is moved.

7. The apparatus according to claim 1, wherein the apparatus receives its power from a power supply of the portable electronic device.

8. The apparatus according to claim 1, further comprising a power source that supplies electrical power to the light source.

9. The apparatus according to claim 1, wherein the predefined event is a timer alert in the portable electronic device, an incoming communications signal on the portable electronic device, movement of the holding device or a signal from a sensor on the portable electronic device.

10. A portable carrying apparatus, comprising:
a portable electronic device;
a holding device that holds the portable electronic device, the holding device comprising:
an activation device that receives signals from the portable electronic device; and
at least one light source coupled to the activation device, wherein the light source selectively illuminates the portable carrying apparatus based on a predefined event, the light source being attached to the holding device.

11. The portable carrying apparatus according to claim 10, wherein the holding device further includes one or more contacts that couple the activation device to the portable electronic device when the holding device holds the portable electronic device.

12. The portable carrying apparatus according to claim 11, wherein when the holding device holds the portable electronic device, the portable electronic device controls the operation of the activation device.

13. The portable carrying apparatus according to claim 11, wherein the contacts intermittently lose touch with the portable electronic device when the holding device is moved such that the light source is intermittently activated when the holding device is moved.

14. The portable carrying apparatus according to claim 10, wherein the holding device receives its power from a power supply of the portable electronic device.

15. The portable carrying apparatus according to claim 10, wherein the holding device includes a power source that supplies electrical power to the light source.

16. The portable carrying apparatus according to claim 10, wherein the predefined event is a timer alert in the portable electronic device, an incoming communications signal on the portable electronic device, movement of the holding device or a signal from a sensor on the portable electronic device.

17. A method for notifying a user of an event utilizing a holding device, the holding device carrying a portable electronic device, the method comprising:
receiving a signal from the portable electronic device, the signal being received by the holding device while carrying the portable electronic device; and
activating at least one light source of the holding device based on the signal received by the holding device.

18. The method according to claim 20, wherein activating the at least one light source comprises illuminating the at least one light source in a predefined manner.

19. The method according to claim 20, wherein the signal from the portable electronic device is based on a timer alert in the portable electronic device, an incoming communications signal on the portable electronic device, movement of the holding device or a signal from a sensor on the portable electronic device.
